(19) United States
(12) Patent Application Publication
(10) Pub. No.: US 2025/0088365 A1
(43) Pub. Date: Mar. 13, 2025

(54) AUTHENTICATION OPTIMIZATION FOR CHATBOT INTERACTIONS

(71) Applicant: American Express Travel Related Services Company, Inc., New York, NY (US)

(72) Inventor: Andras L. Ferenczi, Scottsdale, AZ (US)

(21) Appl. No.: 18/463,359

(22) Filed: Sep. 8, 2023

(51) Int. Cl. H04L 9/32; H04L 51/02

(52) U.S. Cl. CPC H04L 9/3247; H04L 9/3231; H04L 51/02

(57) ABSTRACT

Disclosed are various approaches for authentication optimization for chatbot interactions. A chat request can be received including a cryptographic signature, a client identifier, and an utterance for a chatbot. An artificial intelligence model can be invoked to generate a similarity assessment using the utterance from the chat request, and at least one prior utterance stored in association with the client identifier. Approval or denial to waive validation of the signature can be identified using the similarity assessment and a set of predetermined chat validation rules. Validation of the signature can be omitted or performed based at least in part on the approval or denial decision. The utterance can be transmitted to a chatbot service.

### BACKGROUND

Authentication and digital proof of identity is a mainstay of digital interactions. In the digital world, a person can claim an identity, but if there is no proof of the veracity of the claim, then there can be little assurance that the person is who he or she claims to be. Unlike face-to-face introductions with a trusted person, or the validity provided by conversations in a physical storefront, Internet communications can be much more easily spoofed or falsified.

One example of digital authentication is a digital signature that proves authorship of a document, conversation, or message. The digital signature can be publicly verified using a public source of truth, which can be accessible over a network. Generally, if individual messages include a digital signature, the signature has to be validated with every programmatic request or communication. For example, a server-side authentication system can validate the claims contained in a JavaScript Object Notation (JSON) Web Token (JWT) by verifying the attached signature against the public key supplied by, linked to, or associated with the client. However, verifying every message or request can place unnecessary burdens on the underlying systems as the number of messages, requests, and responses scale.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a sequence diagram illustrating the interactions between portions of the networked environment of FIG. 1 according to various embodiments of the present disclosure.

FIG. 3 is a sequence diagram illustrating the interactions between portions of the networked environment of FIG. 1 and continuing the sequence diagram of FIG. 2 according to various embodiments of the present disclosure.

FIG. 4 is a flowchart illustrating functionality of components of the networked environment of FIG. 1 according to various embodiments of the present disclosure.

FIG. 5 is a flowchart illustrating functionality of components of the networked environment of FIG. 1 and continuing the flowchart of FIG. 4 according to various embodiments of the present disclosure.

### DETAILED DESCRIPTION

Disclosed are various approaches for authentication optimization management of chatbot interactions. Authentication in some systems can include a JavaScript Object Notation (JSON) Web Token (JWT) that is signed using a digital signature. In traditional systems, algorithms such as the Digital Signature Algorithm (DSA), the Rivest-Sha-Adleman algorithm (RSA), Elliptic Curve Digital Signature Algorithm (ECDSA), are often used within current Public Key Infrastructure (PKI). In a post-quantum era, current PKI signature algorithms can be replaced with more processing intensive algorithms for signature verification. For example, quantum safe signature algorithms that are resistant to cryptanalysis using quantum computers can generally be more processing intensive. While the size of the JWT tokens does not increase significantly with the shift to quantum safe signature algorithms, the hardware requirements to validate quantum safe signatures, such as processor and memory requirements, will increase. In other words, verification of post-quantum cryptographic (PQC) signatures can use more server-side computational resources compared to the verification of currently used cryptographic signatures.

The mechanisms described in the present disclosure reduce utilization of client signature verification processes by waiving or omitting client signature verification for chatbot interactions when certain conditions are met. A machine learning AI model can optimize the authentication process for chat-type interactions where APIs and other programmatic interfaces are used by clients to pass utterances to chatbots. The artificial intelligence (AI) model can validate the browser fingerprint and the similarity between utterances received from a client. Over the course of a communications session with multiple successive utterances, the AI model can evaluate a similarity value when each new utterance is received. The similarity value can indicate whether the topic of conversation is continuous or similar in view of the previously received utterances. If the similarity value is identified to have a predetermined relationship to at least one threshold similarity value, then signature verification can be waived. The predetermined relationship can be evaluated by calculating that a value is greater than, less than, equal to, within a predetermined range, or otherwise related to at least one threshold value.

While similarity value is one factor that is considered, all or a subset of the following can be utilized by the AI model and rules-based analyses: (1) whether prior utterances have been received, (2) whether signature validation has been performed for the prior utterances, (3) similarity value of the current utterance in view of the prior utterances (4) risk values associated with a particular type of chat session, (5) whether the user is allowed to have a single chat session or multiple sessions, (6) regional or service-specific risk values, (7) whether a browser fingerprint matches a previous browser fingerprint, (8) an elapsed time since signature validation was performed, among other factors.

The authentication subsystem maintains a history of prior messages received from the client. When the first request comes from client, the JWT (or other post-quantum cryptographically signed data structure) is validated and the authentication subsystem caches or stores the initial request based at least in part on the client identifier provided in the JWT. When next request comes the authorization subsystem invokes a machine learning AI model by passing one or more prior utterance along with the new utterance. The AI model determines whether the utterances are similar, and returns a value indicating a level of similarity. The authentication subsystem can use the level of similarity, a browser fingerprint, regional risk values, and other factors to identify whether to require or waive authentication. Even if the current signature validation is waived, the system can adjust a signature frequency or signature that governs the minimum frequency or maximum time between signature validations.

The system can also store a history of utterances and conversation threads, and can provide this information to another machine learning AI model (or the same AI model) that predicts whether a next utterance that the client is likely to provide. If the prediction value is identified to have a predetermined relationship to at least one threshold prediction value, the system can provide a hint to the chatbot, or can automatically provide the next utterance as input to the chatbot and can cache the chatbot response. If the actual next utterance matches the predicted next utterance exactly, or substantially matches based on a prediction similarity value between the predicted utterance and the actual next utterance. The substantial match can indicate that the actual next utterance is identified to have a predetermined relationship to a threshold prediction similarity value, then the system can automatically respond to the client using the cached response. The actual next utterance can also provide feedback that trains the chat prediction machine learning AI model.

The chatbot management systems can provide a number of improvements over other technologies in the field including: increased efficiency provided by reduced memory, processing, and energy usage by reducing the number of signature validation processes that are performed; increased speed of providing responses to chat requests by predicting future utterances and precaching or storing the results, among other speed and efficiency benefits of these mechanisms relative to devices and systems that do not have the described mechanisms.

In the following discussion, a general description of the chatbot authentication optimization management system is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

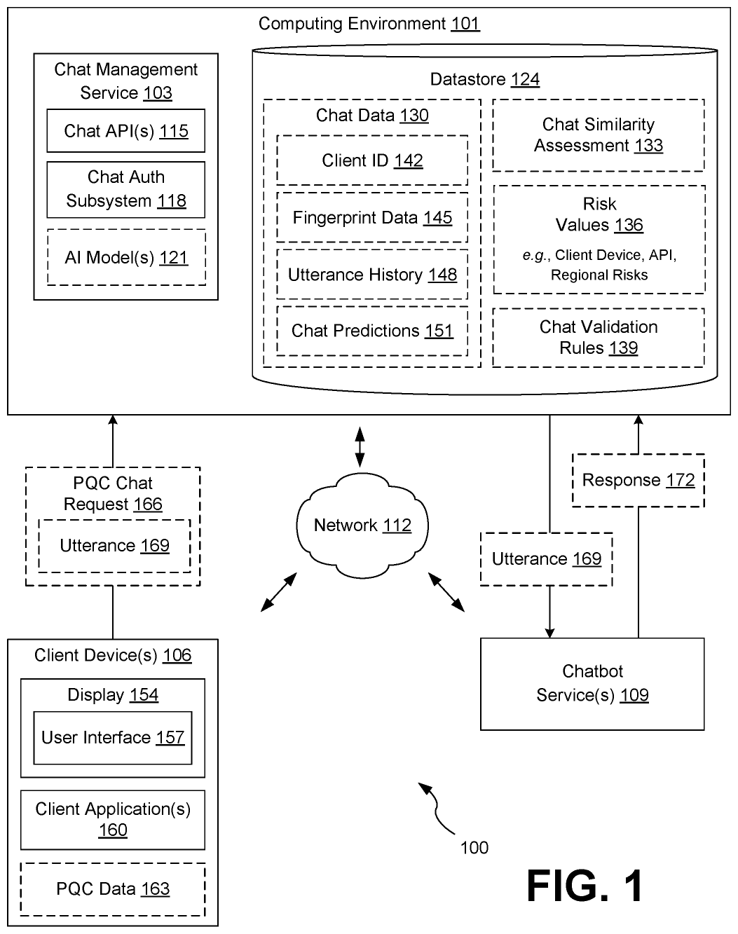

With reference to FIG. 1, shown is a networked environment 100 according to various embodiments. The networked environment 100 can include a computing environment 101 for a chat management service 103, a client device 106, and a chatbot service 109, which can be in data communication with each other via a network 112. Although depicted and described separately, the chatbot service 109 can also be included in or operate as a subcomponent of the computing environment 101 and/or the chat management service 103 in various embodiments of the present disclosure.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 101 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 101 can employ a plurality of computing devices that can be arranged in one or more server banks or computer banks or other arrangements. Such computing devices can be located in a single installation or can be distributed among many different geographical locations. For example, the computing environment 101 can include a plurality of computing devices that together can include a hosted computing resource, a grid computing resource or any other distributed computing arrangement. In some cases, the computing environment 101 can correspond to an elastic computing resource where the allotted capacity of processing, network, storage, or other computing-related resources can vary over time. Various applications or other functionality can be executed in the computing environment 101. The components executed on the computing environment 101 include a chat management service 103, and other applications, services, processes, systems, engines, or functionality not discussed in detail herein.

The chat management service 103 can include one or more chat application programming interfaces (APIs) 115, a chat authentication subsystem 118, one or more artificial intelligence (AI) model 121, and other components. The chat APIs 115 can include a public or private API accessible to the client device 106 over the network 112. The client device 106 can interact with the chatbot service 109 using the chat APIs 115. In other words, the chat management service 103 can expose the chat APIs 115 (or other programmatic interfaces) to provide a front end for interactions with the chatbot service 109, as mediated using the chat authentication subsystem 118 and other components of the chat management service 103.

The chat authentication subsystem 118 can provide authentication services including validation of post-quantum cryptographically signed chat requests 166. The chat authentication subsystem 118 can also determine whether to waive validation for certain post-quantum cryptographically signed chat requests 166, thereby reducing burden of processing requests. The chat authentication subsystem 118 can also predict future chat utterances 169 and determine whether to provide hints or predicted utterances 169 to the chatbot service 109. The chat authentication subsystem 118 or the chatbot service 109 can cache responses 172 to the predicted utterances 169 to provide greater speed of response for predictable conversation paths. The chat authentication subsystem 118 can use AI models 121 to influence these decisions and predictions.

The AI models 121 can include a single AI model 121 or multiple different AI models 121 that perform the various machine learning AI predictions and assessments associated with communications with a chatbot service 109. For example, the chat authentication subsystem 118 can train and use the one or more AI models 121 to generate chat continuity assessments 133, chat predictions 151, and validation waiver decisions in various examples.

Also, various data is stored in a datastore 124 that is accessible to the computing environment 101. The datastore 124 can be representative of a plurality of datastores 124, which can include relational databases or non-relational databases such as object-oriented databases, hierarchical databases, hash tables or similar key-value datastores, as well as other data storage applications or data structures. Moreover, combinations of these databases, data storage applications, and/or data structures can be used together to provide a single, logical, datastore. The data stored in the datastore 124 is associated with the operation of the various applications or functional entities described below. This data can include chat data 130, chat similarity assessment 133, risk values 136, chat validation rules 139, and potentially other data. The chat data 130 can include a client identifier 142, fingerprint data 145, utterance history 148, chat predictions 151, and other data.

The client identifier 142 can include a unique identifier that depends on the client type. The client identifier 142 identifies a user, the client device 106, a client application 160, or another entity associated with the client device 106.

The fingerprint data 145 can include one or more parameters that form a browser fingerprint for a browser, an application fingerprint for a non-browser application 160, or a client fingerprint associated with a client identifier 142 and related devices. The fingerprints can also be referred to as chat fingerprints since the browser of other application 160 can provide the chat user interface. The parameters can include browser attributes, application attributes, or other chat user interface attributes that are detected using transmissions received by the chat management service 103 from the chat user interface of the client device 106. The chat user interface attributes can include a browser or application identifier and version, a device model of the client device 106, an operating system identifier and version, a time zone, preferred language settings, ad blocker used, screen resolution, installed fonts, a hardware specification of the client device 106, and a script- or application-generated image, among other attributes.

A fingerprint can include a hash computed using a hash algorithm and at least a portion of the fingerprint data 145. Alternatively, the fingerprint can include any data structure that includes or is generated using at least a portion of the fingerprint data 145. In various examples, the chat management service 103 or the application 160 can generate a fingerprint using the fingerprint data 145. Where the application 160 generates the fingerprint, the post-quantum cryptographically signed chat request 166 can include the fingerprint. Otherwise, the post-quantum cryptographically signed chat request 166 can include the fingerprint data 145, and the chat management service 103 can extract this information.

The utterance history 148 can include a history of utterances 169. The history can include utterances 169 that are stored in association with a client identifier 142, the fingerprint data 145 or a fingerprint, a session identifier, and other information. The utterance history 148 can include utterances for multiple sessions and for multiple client identifiers 142.

The chat predictions 151 can include predicted utterances 169 that are predicted based at least in part on a current utterance 169 and prior utterances 169 received in succession prior to the current utterance 169. The system can use the utterance history 148 for multiple users to generate chat predictions 151. Since there can be different users that have similar questions or chat utterances, the utterance history 148 can provide insight as to a common chain of discussion. The chat management service 103 can use a dedicated chat prediction AI model 121.

A chat similarity assessment 133 can refer to an assessment of whether a currently received utterance 169 is similar to one or more prior utterances 169 received in succession directly before the current utterance 169. In the various embodiments, the chat similarity assessment 133 can refer to a binary output indicating ‘similar’ or ‘not similar;’ a ternary output of ‘similar,’ ‘not similar,’ or ‘undetermined;’ or a numeric or symbolic value indicating confidence in similarity. An AI model 121, such as a similarity assessment AI model 121, can generate the chat similarity assessment 133 based at least in part on a current utterance 169 and prior utterances 169 received in succession prior to the current utterance 169. If the chat similarity assessment 133 indicates similarity value identified to have a predetermined relationship to a threshold similarity value, the validation of the signature validation is bypassed. The signature can be computed based at least in part on the payload of the request, so can vary between requests.

The similarity assessment AI model 121 can include a vector embedding similarity model. The system can create vector embeddings based at least in part on the utterances 169 and store them in a vector embedding database for semantic searches and application of similarity metrics. The vector embeddings can include n-dimensional coordinates that are generated based at least in part on an input utterance 169. The similarity assessment AI model 121 can use vector embeddings to compute numerical similarity scores that identify semantic similarities based at least in part on the current utterance 169 and a set of one or more prior utterances 169. The vector embedding similarity AI model 121 can use one or more similarity metrics such as Euclidian distance, Cosine similarity, dot product similarity, and other similarity metrics to compare vector embeddings of the utterances 169.

The similarity assessment AI model 121 can additionally or alternatively include a Siamese neural network architecture that is designed to learn relationships between pairs of inputs. The Siamese-type similarity assessment AI model 121 can include two identical neural networks, each taking one input from the pair, and the two networks are trained to learn a similarity metric between the two inputs. The two identical neural networks can share the same weights and architecture, and can be trained to output a feature vector representation for each input. These feature vectors are then compared using a distance or similarity metric, such as Euclidean distance or cosine similarity, to determine the similarity between the two inputs.

The similarity assessment AI model 121 can also use the utterance history 148 to identify historical examples of semantically similar chat sessions or those with a similar topic. These historical examples can include those with the same and other clients. The similarity assessment AI model 121 can use these historical examples from the utterance history 148 to tip, hint, train, and otherwise affect the similarity assessment 133 of the similarity assessment AI model 121. The historical examples can include historical utterances 169 that are similar to the current utterance 169 and prior utterances 169, but can also include utterances 169 that are subsequent to a historical utterance that matches the current utterance. These subsequent utterances 169 can also be used to tip, hint, train, and otherwise affect chat predictions 151 generated using a chat prediction AI model 121. In some examples, the similarity assessment AI model 121 and the chat prediction AI model 121 can be part of a single AI model 121.

The risk values 136 can refer to risk valuations identified by the chat management service 103. The chat management service 103 can generate the various risk values 136, and can receive the risk values 136 from one or more risk assessment network services accessed over the network 112. The risk values 136 can include a client risk assessment for the client device 106, the chat session, the user of the client device 106. The risk values 136 can include an overall chatbot or API risk assessment for the chatbot service 109, the chat API 115, and other components of the chat management service 103 as a whole.

The client risk assessment can consider various risks associated with items such as a region where the client device 106 is located, the utterance 169 content, the fingerprint data 145, a user of the client device 106, a network identifier, and other risks. The chatbot risk assessment can consider a regional risk of a region or regions where the chatbot service 109, the chat API 115, and other components of the chat management service 103 are located. The chatbot risk assessment can also include an assessment of known existing attacks, non-normative interactions, and suspicious interactions with the chatbot service 109, the chat API 115, and other components of the chat management service 103.

The chat validation rules 139 can indicate rules that govern whether to waive validation for post-quantum cryptographically signed chat requests 166. As nonlimiting examples, the chat validation rules 139 can indicate a maximum number of successive utterances 169 for which PQC validation can be waived regardless chat similarity assessment 133, a number of maximum number of successive utterances 169 for which PQC validation can be waived for successive utterances 169 with a chat similarity assessment 133 that has a predetermined relationship with at least one threshold similarity assessment value. The chat validation rules 139 can additionally or alternatively indicate a base number successive utterances 169 for which PQC validation can be waived and adjust the number of successive utterances 169 that are allowed based at least in part on the chat similarity assessment 133 and the current risk values 136. The chat validation rules 139 can additionally or alternatively include rules that can approve or deny a validation waiver for a particular post-quantum cryptographically signed chat request 166 based at least in part on the chat similarity assessment 133 and the current risk values 136. The chat validation rules 139 can also ensure that PQC validation is performed for a predetermined set of chatbot services 109, a predetermined set of topics or terms detected in an utterance 169, a predetermined set of risk values 136 identified for the client or chat, and other rules.

The client device 106 is representative of a plurality of client devices 106 that can be coupled to the network 112. The client device 106 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 106 can include one or more displays 154, such as liquid crystal displays (LCDs), gas plasma-based flat panel displays, organic light emitting diode (OLED) displays, electrophoretic ink (“E-ink”) displays, projectors, or other types of display devices. In some instances, the displays 154 can be a component of the client device 106 or can be connected to the client device 106 through a wired or wireless connection.

The client device 106 can be configured to execute various applications such as a client application 160 or other applications. The client application 160 can be executed in a client device 106 to access network content served up by the computing environment 101 or other servers, thereby rendering a user interface 157 on the displays 154. To this end, the client application 160 can include a browser, a dedicated application, or other executable, and the user interface 157 can include a network page, an application screen, or other user mechanism for obtaining user input. The client device 106 can be configured to execute client applications 160 such as browser applications, chat applications, messaging applications, email applications, social networking applications, word processors, spreadsheets, or other applications.

The PQC data 163 can include a PQC signature generation algorithm and a public key encapsulation mechanism, among other signature generation and verification data. It should be noted that PQC data 163 is indicated as one example of cryptographic data that can be used along with the concepts of this disclosure. Any existing cryptographic methods and any future cryptographic methods can be used with the present disclosure. Additional processing savings can be realized as cryptographic method become more hardware intensive. The PQC signature generation algorithm can be part of a PQC schema. A PQC schema can include a PQC signature generation algorithm, a PQC signature verification algorithm, and other information. The PQC schema utilized can include one or more of CRYSTALS-Dilithium, FALCON, Rainbow, SPHINCS+, a bespoke PQC schema, a customized or modified version of a PQC schema, or a combination thereof. The PQC schema can include quantum-safe PKI schemas or non-PKI schemas that do not use a public key. The PQC schema can use signature generation and verification algorithms that are code-based quantum-safe cryptography, hash-based quantum-safe cryptography, lattice-based quantum-safe cryptography, isogeny-based quantum-safe cryptography, multivariate-based quantum-safe cryptography, and other quantum-safe cryptographic technologies. The PQC data 163 can include a public-key encapsulation mechanisms (KEMs) such as CRYSTALS-KYBER and other mechanisms.

The client application 160 can generate a post-quantum or otherwise cryptographically signed chat request 166. The post-quantum cryptographically signed chat request 166 can include a post-quantum or quantum-safe chat request that includes an utterance 169 and a PQC signature. The post-quantum cryptographically signed chat request 166 can include a JWT or another data structure that can include an utterance 169 and a PQC signature, as well information that specifies a PQC schema or algorithm for verification and validation. For example, the post-quantum cryptographically signed chat request 166 can include a header or another portion that contains information about the type of algorithms used to generate the signature, a payload containing the claims made by the user that can include a client identifier 142 or user identifier and metainformation about the operation of the token, and a PQC signature that is used to verify the integrity of the post-quantum cryptographically signed chat request 166 or a token therein. The utterance 169 can be included in the header or payload in various examples.

The client application 160 can generate the post-quantum cryptographically signed chat request 166, or the data structure within the request, using the PQC data 163. As a result, the post-quantum cryptographically signed chat request 166 can include a signature generated using a PQC signature generation algorithm of a PQC schema. The post-quantum cryptographically signed chat request 166 can include information that identifies the PQC signature generation algorithm or schema. The chat authentication subsystem 118 use the KEM to identify the PQC schema and PQC verification algorithm based at least in part on the information specified in the post-quantum cryptographically signed chat request 166.

The chat authentication subsystem 118 can validate signatures of a post-quantum cryptographically signed chat request 166 by performing a verification and validation process using the PQC schema specified in the post-quantum cryptographically signed chat request 166. Specific PQC verification algorithms can include CRYSTALS-Dilithium, FALCON, Rainbow, SPHINCS+, and others. The chat authentication subsystem 118 use a KEM to identify the PQC verification algorithm based at least in part on PQC verification information specified in the post-quantum cryptographically signed chat request 166.

The utterance 169 can refer to a user-entered chat that is to be provided as input to the chatbot service 109. The response 172 can refer to a chat response generated by the chatbot service 109 in response to the utterance 169. The chatbot service 109 can refer to any service that generates chat or message type responses 172 based at least in part on an utterance 169 or a string of utterances 169. This can include general knowledge services, Internet search services, helpdesk services, and other services.

The following sequence diagrams and flowcharts provide a general description of the operation of the various components of the networked environment 100. Although the general descriptions can provide provides an example of the interactions between the various components of the networked environment 100, other interactions between the various components of the networked environment 100 are also possible according to various embodiments of the present disclosure. Interactions described with respect to a particular figure or sequence diagram can also be performed in relation to the other figures and sequence diagrams herein.

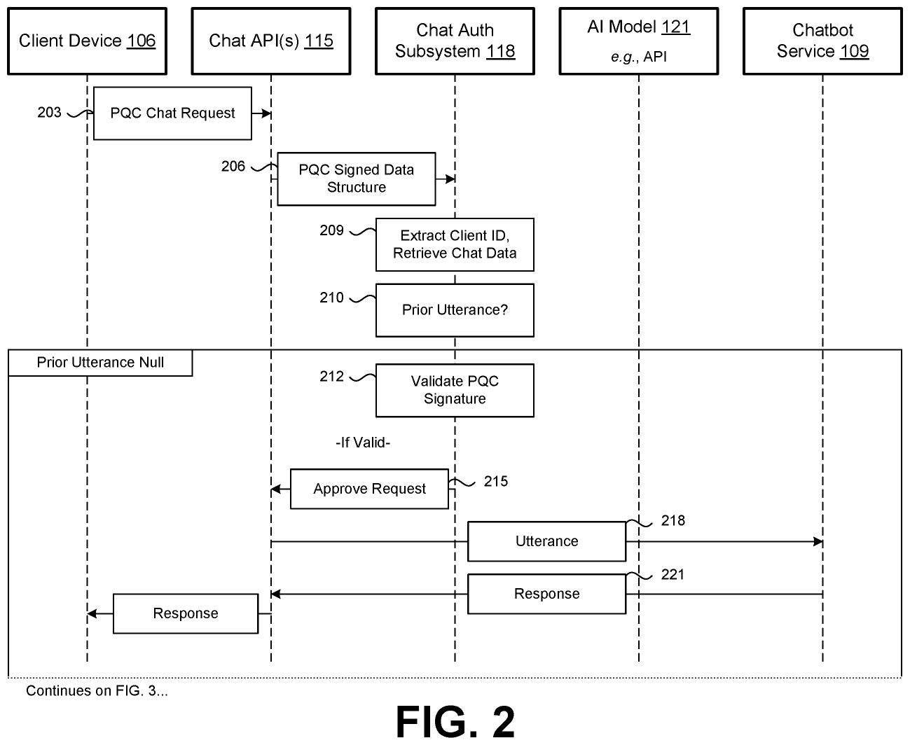

Referring next to FIG. 2, shown is a sequence diagram that provides one example of the interactions between the components of the networked environment 100 for authentication optimization management of chatbot interactions. The sequence diagram of FIG. 2 provides merely an example of the many different types of functional arrangements that can be employed to implement the depicted interactions between the components of the networked environment 100. As an alternative, the sequence diagram of FIG. 2 can be viewed as depicting an example of elements of a method implemented within the networked environment 100.

Beginning with block 203, the client device 106 can transmit a registration request to the chat management service 103. The registration request can request to instate a relationship such as a membership with a company that provides identity services, fiscal services, consumer services, information services, and other types of services. The relationship can also include a company joining as a member of a business network that enables services provided and managed by the chat management service 103 and related components.

In block 203, the client device 106 can transmit a post-quantum cryptographically signed chat request 166 to the chat API 115. The post-quantum cryptographically signed chat request 166 can include a PQC or other cryptographic signature and an utterance 169. This example describes and example of a PQC signature, but the process is applicable to any existing or future cryptographic method. In some examples, the post-quantum cryptographically signed chat request 166 can include parameters identifying a target chatbot service 109, the client device 106, a client identifier 142, fingerprint data 145, and other information. The post-quantum cryptographically signed chat request 166 can include a signature generated using a PQC signature generation algorithm. The post-quantum cryptographically signed chat request 166 can include information that identifies the PQC signature generation algorithm or associated schema.

In block 206, the chat API 115 can provide a post-quantum cryptographically signed JWT or other post-quantum cryptographically signed data structure to the chat authentication subsystem 118. In some examples, post-quantum cryptographically signed chat request 166 is the post-quantum cryptographically signed JWT, and the chat API 115 simply forwards it to the chat authentication subsystem 118. In some examples, the post-quantum cryptographically signed JWT includes the utterance 169, and the API 115 can extract and cache or otherwise store the utterance 169. In an instance where the post-quantum cryptographically signed JWT and the utterance 169 are separate parts of the post-quantum cryptographically signed chat request 166, the API 115 can extract the post-quantum cryptographically signed JWT from the request and provide it to the chat authentication subsystem 118.

In block 209, the chat authentication subsystem 118 can extract a client identifier 142 and other chat data 130 from the post-quantum cryptographically signed JWT and retrieve or request chat data 130 based at least in part on the client identifier 142. In other words, the chat authentication subsystem 118 can identify chat data 130 using the client identifier 142 as a key to retrieve the information stored in association with the client identifier 142. The client identifier 142 and other chat data 130 can be included as parameters in a header, body, payload, or otherwise included with the post-quantum cryptographically signed chat request 166. The chat data 130 can include one or more prior utterances 169 that were submitted sequentially prior to the current utterance 169 in the post-quantum cryptographically signed chat request 166. In some examples, the chat authentication subsystem 118 can retrieve a predetermined maximum number of prior utterances 169.

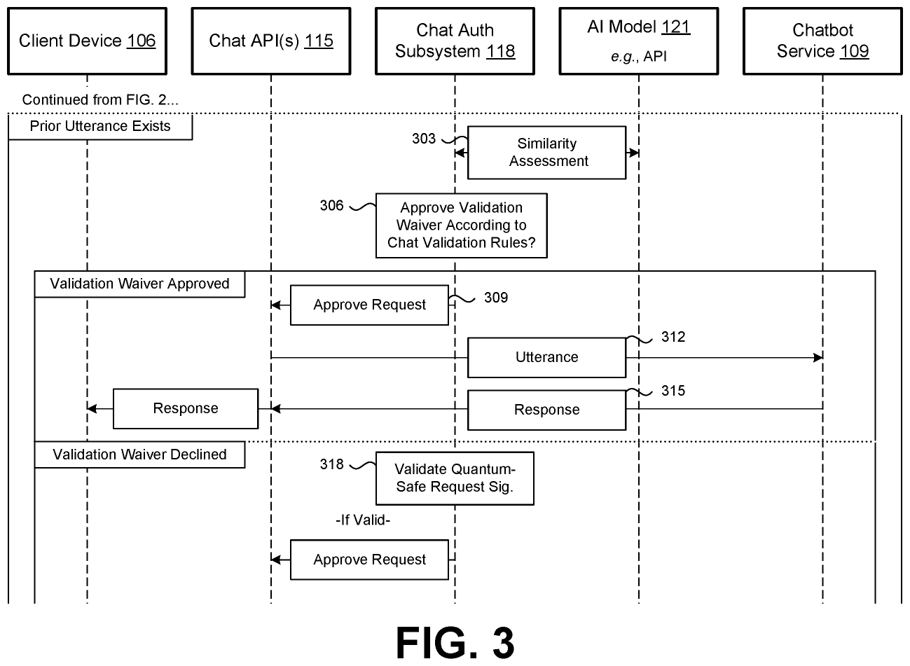

In block 210, the chat authentication subsystem 118 can identify whether the chat data 130 includes a sequentially submitted prior utterance 169. In some cases, the chat data 130 can include a prior utterance 169 that was submitted in association with the client identifier 142, but was submitted a threshold time before the current utterance 169. These prior utterances 169 can be disqualified from use based at least in part on a maximum threshold time according to the chat validation rules 139. If there is no qualifying prior utterance 169, then the chat authentication subsystem 118 can move to block 212. Otherwise, the chat authentication subsystem 118 can proceed to block 303 in FIG. 3.

In block 212, the chat authentication subsystem 118 can validate the PQC signature of the post-quantum cryptographically signed chat request 166. The chat authentication subsystem 118 use the KEM to identify the PQC schema and PQC verification algorithm based at least in part on the information specified in the post-quantum cryptographically signed chat request 166. The chat authentication subsystem 118 can validate PQC signatures of a post-quantum cryptographically signed chat request 166 by performing a verification and validation process using the PQC schema specified in the post-quantum cryptographically signed chat request 166. If the signature is validated, the chat authentication subsystem 118 can proceed to block 212. If the signature is invalidated, the chat authentication subsystem 118 can reject the post-quantum cryptographically signed chat request 166.

In block 215, the chat authentication subsystem 118 can transmit an indication that the post-quantum cryptographically signed chat request 166 is approved. For example, the chat API 115 can include a process that receives a request from the client device 106, programmatically invokes the chat authentication subsystem 118 for approval of the post-quantum cryptographically signed chat request 166, and then forwards the utterance 169 in an instance in which the chat authentication subsystem 118 indicates that the post-quantum cryptographically signed chat request 166 is approved. In some examples, the chat authentication subsystem 118 or the chat API 115 can save the current utterance 169 and other chat data 130 in the datastore 124 in response to a validation of the post-quantum cryptographically signed chat request 166. This enables the chat authentication subsystem 118 to maintain an utterance history 148 of one or more prior utterances 169 received in association with the client identifier 142 or client device 106.

In block 218, the chat API 115 can transmit the utterance 169 to the chatbot service 109. Alternatively, the chat authentication subsystem 118 can transmit the utterance 169 to the chatbot service 109. For example, in an instance in which the JWT or other PQC signed data structure include the utterance 169, the chat authentication subsystem 118 can authenticate with the chatbot service 109 and transmit the utterance 169. However, in further examples where the chat API 115 includes authentication credentials or otherwise is enabled to access the chatbot service 109 rather than the chat authentication subsystem 118, the chat API 115 can transmit the utterance 169 to the chatbot service 109. In examples where the chat API 115 does not store or cache the utterance 169, the chat authentication subsystem 118 invokes the chat API 115 with a call that includes the utterance 169.

In block 221, the chat API 115 can receive the response 172. The chat API 115 can then transmit the response 172 to the client device 106. In examples where the chat authentication subsystem 118 transmits the utterance 169 to the chatbot service 109, the chat authentication subsystem 118 can receive the response 172. The chat authentication subsystem 118 can then return the response 172 to the client device 106 or provide the response 172 to the chat API 115.

FIG. 3 shows a sequence diagram that expands on the sequence diagram of FIG. 2, providing an example of authentication optimization management of chatbot interactions. The sequence diagram of FIG. 3 provides merely an example of the many different types of functional arrangements that can be employed to implement the depicted interactions between the components of the networked environment 100. As an alternative, the sequence diagram of FIG. 3 can be viewed as depicting an example of elements of a method implemented within the networked environment 100. Generally, the sequence diagram of FIG. 3 can be understood as continuing from block 210 of FIG. 2 in an instance in which a qualifying prior utterance 169 exists and is retrieved.

In block 303, the chat authentication subsystem 118 can generate a chat similarity assessment 133. The chat authentication subsystem 118 can invoke a machine learning AI model 121 by passing the at least one prior utterance 169 retrieved from the chat data 130, as well as the new utterance 169 from the post-quantum cryptographically signed chat request 166. The AI model 121 determines whether the utterances 169 are similar and returns a similarity value as a chat similarity assessment 133.

In block 306, the chat authentication subsystem 118 can determine whether to approve or deny a validation waiver according to the chat validation rules 139. The chat authentication subsystem 118 can use the chat similarity assessment 133, fingerprint data 145, risk values 136, and utterance history 148 to identify whether to require or waive validation of the post-quantum cryptographically signed chat request 166, and whether to perform another action such as adjustment of PQC signature validation frequency, time, or number of utterances 169. The chat authentication subsystem 118 can use a different PQC signature validation frequency, time, and number of utterances 169 for utterances 169 that are more similar than a threshold similarity value as compared to utterances 169 that are less similar than the threshold similarity value. If the validation waiver is approved the process can move to block 309, and if declined the process can move to block 318.

In block 309, the chat authentication subsystem 118 can transmit an indication that the post-quantum cryptographically signed chat request 166 is approved. For example, the chat API 115 can include a process that receives a request from the client device 106, programmatically invokes the chat authentication subsystem 118 for approval of the post-quantum cryptographically signed chat request 166, and then forwards the utterance 169 in an instance in which the chat authentication subsystem 118 indicates that the post-quantum cryptographically signed chat request 166 is approved. In some examples, the chat authentication subsystem 118 or the chat API 115 can save the current utterance 169 and other chat data 130 in the datastore 124 in response to a validation of the post-quantum cryptographically signed chat request 166. This enables the chat authentication subsystem 118 to maintain an utterance history 148 of one or more prior utterances 169 received in association with the client identifier 142 or client device 106.

In block 312, the chat API 115 can transmit the utterance 169 to the chatbot service 109. Alternatively, the chat authentication subsystem 118 can transmit the utterance 169 to the chatbot service 109. For example, in an instance in which the JWT or other PQC signed data structure includes the utterance 169, the chat authentication subsystem 118 can authenticate with the chatbot service 109 and transmit the utterance 169. However, in further examples where the chat API 115 includes authentication credentials or otherwise is enabled to access the chatbot service 109 rather than the chat authentication subsystem 118, the chat API 115 can transmit the utterance 169 to the chatbot service 109. In examples where the chat API 115 does not store or cache the utterance 169, the chat authentication subsystem 118 can invoke the chat API 115 with a call that includes the utterance 169.

In block 315, the chat API 115 can receive the response 172. The chat API 115 can then transmit the response 172 to the client device 106. In examples where the chat authentication subsystem 118 transmits the utterance 169 to the chatbot service 109, the chat authentication subsystem 118 can receive the response 172. The chat authentication subsystem 118 can then return the response 172 to the client device 106 or provide the response 172 to the chat API 115.

In block 318, the chat authentication subsystem 118 can validate the PQC signature of the post-quantum cryptographically signed chat request 166. The chat authentication subsystem 118 use the KEM to identify the PQC schema and PQC verification algorithm based at least in part on the information specified in the post-quantum cryptographically signed chat request 166. The chat authentication subsystem 118 can validate PQC signatures of a post-quantum cryptographically signed chat request 166 by performing a verification and validation process using the PQC schema specified in the post-quantum cryptographically signed chat request 166. If the signature is validated, the chat authentication subsystem 118 can proceed substantively as described in blocks 309-315. If the signature is not validated, the chat authentication subsystem 118 can reject the post-quantum cryptographically signed chat request 166.

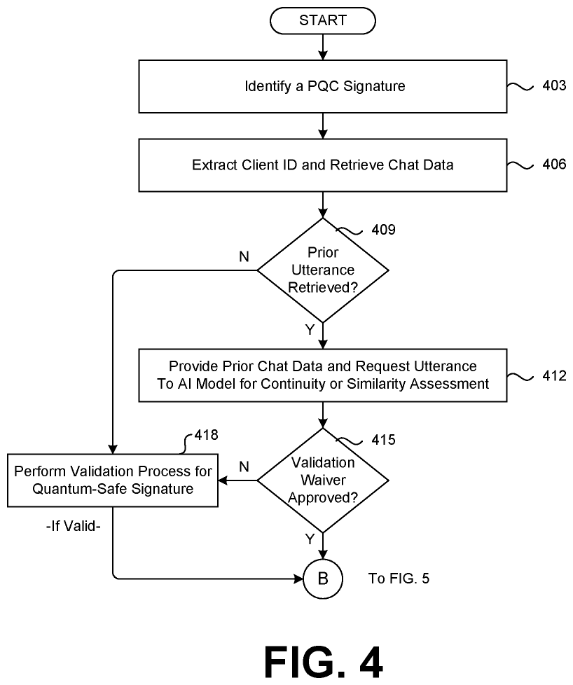

FIG. 4 shows a flowchart providing an example of authentication optimization management of chatbot interactions. The flowchart of FIG. 4 provides merely an example of the many different types of functional arrangements that can be employed to implement the depicted interactions between the components of the networked environment 100. As an alternative, the flowchart of FIG. 4 can be viewed as depicting an example of elements of a method implemented within the networked environment 100. While the chat authentication subsystem 118 or another specific component can be indicated to perform a particular block, any portion of the chat management service 103 can perform all or a portion of the same block in association with the chatbot service 109.

In block 403, the chat authentication subsystem 118 can identify or receive a PQC signature. For example, the chat API 115 can provide the PQC signature individually or along with post-quantum cryptographically signed JWT received as a post-quantum cryptographically signed chat request 166 from a client device 106.

In block 406, the chat authentication subsystem 118 can extract a client identifier 142 using the post-quantum cryptographically signed JWT. The chat authentication subsystem 118 can then identify or request chat data 130 based at least in part on the client identifier 142. The chat data 130 can include one or more prior utterances 169 that were submitted sequentially prior to the current utterance 169 in the post-quantum cryptographically signed chat request 166. In some examples, the chat authentication subsystem 118 can retrieve a predetermined maximum number of prior utterances 169.

In block 409, the chat authentication subsystem 118 can identify whether the retrieved chat data 130 includes a sequentially submitted prior utterance 169. In some cases, the chat data 130 can include a prior utterance 169 that was submitted in association with the client identifier 142, but was submitted a threshold time before the current utterance 169. The chat authentication subsystem 118 can disqualify or filter certain prior utterances 169 from use based at least in part on a maximum threshold time in the utterance history 148, according to the chat validation rules 139. If there is a qualifying prior utterance 169, then the chat authentication subsystem 118 can move to block 412 and 415. Otherwise, the chat authentication subsystem 118 can proceed to block 418.

In block 412, the chat authentication subsystem 118 can generate a chat similarity assessment 133. The chat authentication subsystem 118 can invoke a machine learning AI model 121 by passing the at least one prior utterance 169 retrieved from the prior chat data 130, as well as the new utterance 169 from the post-quantum cryptographically signed chat request 166. The AI model 121 can determine whether the utterances 169 are similar and return a similarity value as a chat similarity assessment 133.

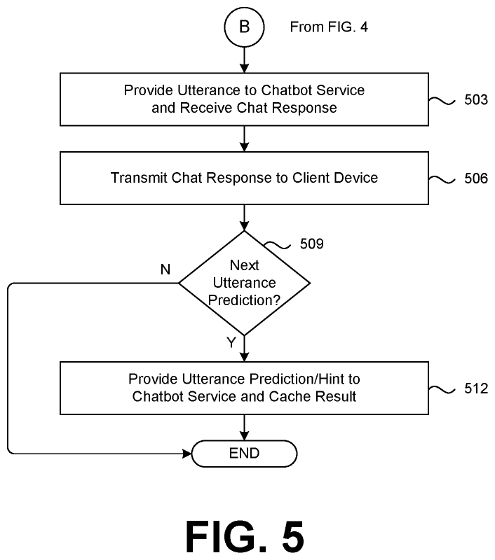

In block 415, the chat authentication subsystem 118 can determine whether to approve or deny a validation waiver according to the chat validation rules 139. The chat authentication subsystem 118 can use the chat similarity assessment 133, fingerprint data 145, risk values 136, and utterance history 148 to identify whether to require or waive validation of the post-quantum cryptographically signed chat request 166, and whether to perform another action such as adjustment of PQC signature validation frequency, time, or number of utterances 169. The chat authentication subsystem 118 can use a different PQC signature validation frequency, time, and number of utterances 169 for utterances 169 that are more similar than a threshold similarity value as compared to utterances 169 that are less similar than the threshold similarity value. If the validation waiver is approved the process can move to connector B, which connects to FIG. 5. If declined the process can move to block 418.

In block 418, the chat authentication subsystem 118 can perform a validation process for the PQC signature of the post-quantum cryptographically signed chat request 166. The chat authentication subsystem 118 can identify the PQC schema and PQC verification algorithm based at least in part on the information specified in the post-quantum cryptographically signed chat request 166. The chat authentication subsystem 118 can validate PQC signatures of a post-quantum cryptographically signed chat request 166 by performing a verification and validation process using the specified PQC schema. If the signature is validated, the chat authentication subsystem 118 can proceed to connector B, which connects to FIG. 5. If the signature is invalidated, the chat authentication subsystem 118 can reject the post-quantum cryptographically signed chat request 166.

FIG. 5 shows a flowchart that expands on the flowchart of FIG. 4, providing an example of authentication optimization management of chatbot interactions. The flowchart of FIG. 5 provides merely an example of the many different types of functional arrangements that can be employed to implement the depicted interactions between the components of the networked environment 100. As an alternative, the flowchart of FIG. 5 can be viewed as depicting an example of elements of a method implemented within the networked environment 100. While a particular component can be indicated to perform a particular block, any portion of the chat management service 103 can perform all or a portion of the same block in association with the chatbot service 109.

In block 503, the chat management service 103 can transmit the utterance 169 to the chatbot service 109. The chatbot service 109 can return a chat response 172. In the various embodiments, the chat API 115 or the chat authentication subsystem 118 can transmit the utterance 169. For example, in an instance in which the JWT or other PQC signed data structure include the utterance 169, the chat authentication subsystem 118 can authenticate with the chatbot service 109 and transmit the utterance 169. However, in further examples where the chat API 115 includes authentication credentials or otherwise is enabled to access the chatbot service 109 rather than the chat authentication subsystem 118, the chat API 115 can transmit the utterance 169 to the chatbot service 109. In examples where the chat API 115 does not store or cache the utterance 169, the chat authentication subsystem 118 invokes the chat API 115 with a call that includes the utterance 169.

In block 506, the chat management service 103 can receive the response 172. For example, the chat API 115 can receive the response 172. The chat API 115 can then transmit the response 172 to the client device 106. In examples where the chat authentication subsystem 118 transmits the utterance 169 to the chatbot service 109, the chat authentication subsystem 118 can receive the response 172. The chat authentication subsystem 118 can then return the response 172 to the client device 106 or provide the response 172 to the chat API 115.

In block 509, the chat authentication subsystem 118 can predict future chat utterances 169 and determine whether to provide hints or predicted utterances 169 to the chatbot service 109. The chat authentication subsystem 118 can use a chat prediction AI model 121 to generate chat predictions 151. The AI model 121 can generate chat predictions 151 based at least in part on inputs that include a current utterance 169 and prior chat data 130. The prior chat data 130 can include utterances 169 received in succession prior to the current utterance 169 as well as utterances 169 associated with other client identifiers 143 in the utterance history 148. Since there can be different users that have similar questions or chat utterances, the utterance history 148 can provide insight as to a common chain of discussion. The AI model 121 can also provide a confidence value in addition to or in lieu of a chat prediction 151. In the various examples, if the chat prediction 151 is generated, or if the prediction confidence value is identified to have a predetermined relationship with a threshold confidence value, then the chat authentication subsystem 118 can move to block 512. Otherwise, the process can end.

In block 512, the chat authentication subsystem 118 can transmit the chat prediction 151 or a hint to the chatbot service 109. In some examples, the chatbot service 109 can return a response 172 to the chat prediction 151. The chat authentication subsystem 118 can cache responses 172 to the chat prediction 151 to provide greater speed of response for predictable conversation paths. If a next utterance 169 received from the client device 106 matches the chat prediction 151, then the chat authentication subsystem 118 can return the cached response 172 to the chat prediction 151, and can train the AI model 121 to reinforce its operation.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages could be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) can also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
at least one computing device comprising at least one processor and at least one memory; and
machine-readable instructions stored in the at least one memory that, when executed by the at least one processor, cause the at least one computing device to at least:
receive a chat request comprising a post-quantum cryptographic (PQC) signature, a client identifier, and an utterance;
retrieve at least one prior utterance stored in association with the client identifier;
invoke a similarity assessment artificial intelligence (AI) model using the utterance from the chat request, and the at least one prior utterance, wherein the similarity assessment AI model generates a similarity assessment;
approve a PQC validation waiver that waives validation of the PQC signature based at least in part on the similarity assessment and a set of predetermined chat validation rules; and
transmit the utterance to a chatbot service without validation of the PQC signature in an instance in which the PQC validation waiver is approved.

2. The system of claim 1, wherein the similarity assessment AI model comprises a vector similarity model that compares similarities of vector embeddings corresponding to the utterance and the at least one prior utterance.

3. The system of claim 2, wherein the similarity assessment AI model retrieves the vector embeddings corresponding to the at least one prior utterance from a vector embedding database.

4. The system of claim 1, wherein the chat request comprises a JavaScript Object Notation (JSON) Web Token (JWT) that includes the PQC signature.

5. The system of claim 1, wherein the similarity assessment corresponds to at least one of: a binary value, a ternary value, a numeric value, a symbolic value, or any combination thereof.

6. The system of claim 1, wherein the chat request is received using an application programming interface provided as an interface for the chatbot service.

7. The system of claim 1, wherein the chat request comprises fingerprint data comprising information associated with an interface through which the utterance is user-entered for submission to the chatbot service.

8. A method, comprising:
receiving a chat request comprising a cryptographic signature, a client identifier, and an utterance;
retrieving at least one prior utterance stored in association with the client identifier;
invoking a similarity assessment artificial intelligence (AI) model using the utterance from the chat request, and the at least one prior utterance, wherein the similarity assessment AI model generates a similarity assessment;
identifying a signature validation decision that indicates an approval or a denial to waive validation of the cryptographic signature, wherein the signature validation decision is identified based at least in part on the similarity assessment and a set of predetermined chat validation rules; and
transmitting the utterance to a chatbot service, wherein the utterance is transmitted:
without performing a cryptographic validation of the cryptographic signature in an instance in which the signature validation decision indicates the approval, or
subsequently to performing the cryptographic validation of the cryptographic signature in an instance in which the signature validation decision indicates the denial.

9. The method of claim 8, further comprising:
invoking an utterance prediction AI model using the utterance and the at least one prior utterance, wherein the utterance prediction AI model generates an utterance prediction output comprising at least one of: a predicted utterance and a confidence value.

10. The method of claim 9, further comprising:
transmitting the predicted utterance or a hint to the chatbot service based at least in part on the utterance prediction output.

11. The method of claim 8, wherein the similarity assessment AI model comprises a vector similarity model that compares similarities of vector embeddings corresponding to the utterance and the at least one prior utterance.

12. The method of claim 11, wherein the similarity assessment AI model retrieves the vector embeddings corresponding to the at least one prior utterance from a vector embedding database.

13. The method of claim 8, wherein the chat request comprises a JavaScript Object Notation (JSON) Web Token (JWT) that includes the PQC signature.

14. The method of claim 8, wherein the similarity assessment corresponds to at least one of: a binary value, a ternary value, a numeric value, a symbolic value, or any combination thereof.

15. A non-transitory computer readable medium comprising machine-readable instructions that, when executed by at least one processor, cause at least one computing device to at least:
receive a chat request comprising a cryptographic signature, a client identifier, and an utterance;
invoke a similarity assessment artificial intelligence (AI) model using the utterance from the chat request, and at least one prior utterance stored in association with the client identifier, wherein the similarity assessment AI model generates a similarity assessment;
identify an approval or a denial to waive a cryptographic validation of the cryptographic signature, wherein the approval or the denial is identified based at least in part on: the similarity assessment and a set of predetermined chat validation rules; and
transmit the utterance to a chatbot service, wherein the cryptographic validation of the cryptographic signature is omitted in an instance in which the approval is identified, or performed in an instance in which the denial is identified.

16. The non-transitory computer readable medium comprising of claim 15, wherein the instructions cause the at least one computing device to at least:
invoke an utterance prediction AI model using the utterance and the at least one prior utterance, wherein the utterance prediction AI model generates an utterance prediction output comprising at least one of: a predicted utterance and a confidence value.

17. The non-transitory computer readable medium comprising of claim 16, wherein the instructions cause the at least one computing device to at least:
transmit the predicted utterance or a hint to the chatbot service based at least in part on the utterance prediction output.

18. The non-transitory computer readable medium comprising of claim 15, wherein the similarity assessment AI model comprises a vector similarity model that compares similarities of vector embeddings corresponding to the utterance and the at least one prior utterance.

19. The non-transitory computer readable medium comprising of claim 18, wherein the similarity assessment AI model retrieves the vector embeddings corresponding to the at least one prior utterance from a vector embedding database.

20. The non-transitory computer readable medium comprising of claim 15, wherein the chat request comprises a JavaScript Object Notation (JSON) Web Token (JWT).
